(19) United States
(12) Patent Application Publication
(10) Pub. No.: US 2023/0345597 A1
(43) Pub. Date: Oct. 26, 2023

(54) DEVICE AND METHOD FOR ADJUSTING LIGHT ACCORDING TO TEMPERATURE

(71) Applicant: Fuzhou Sen Yin line Information Technology Co., Ltd., Fuzhou (CN)

(72) Inventor: ZEAN SU, Fuzhou (CN)

(21) Appl. No.: 17/728,868

(22) Filed: Apr. 25, 2022

(51) Int. Cl. H05B 45/18; H05B 45/28

(52) U.S. Cl. CPC H05B 45/18; H05B 45/28; G01K 7/34

(57) ABSTRACT

A device and method for adjusting light according to temperature, the device comprises a temperature detection circuit, a control circuit, a drive circuit and a light-emitting circuit, wherein the control circuit is respectively connected with the temperature detection circuit and the drive circuit, the drive circuit is connected with the light-emitting circuit; the temperature detection circuit is configured to detect the temperature information of a target device, and convert the temperature information into a feedback signal; the control circuit is configured to adjust a driving signal input to the drive circuit according to the feedback signal; the drive circuit is configured to adjust a light-emitting state of the light-emitting circuit according to the driving signal. The color, the intensity changes, and a periodic on or off of the light are adjusted according to the temperature which could present a dynamic effect and is full of life interest.

### TECHNICAL FIELD

The present disclosure relates to the technical filed of smart device, and in particular to a device and method for adjusting light according to temperature.

### BACKGROUND

At present, the indicator lights of most products on the market are controlled by preset programs, and the presentation effect is inflexible, which is difficult to reflect the running state of the product and lacks of interest in life. For example, the electric water heating equipment on the market usually uses a fixed color light to indicate the boiling water state of the product and only can distinguish between working and non-working states, and it is difficult to instantly indicate the water boiling state of the electric water heating equipment.

In view of this, it is an urgent problem to be solved in this technical field to overcome the deficiencies existing in this prior art and product.

### SUMMARY

The present disclosure provides a device and method for adjusting light according to temperature, which can adjust the color, intensity changes and dynamic effects of periodic lights on and off according to temperature changes, so as to provide real-time feedback of the running state, which is full of life interest.

In order to solve the above-mentioned technical problems, a technical solution adopted in the present disclosure is to provide a device for adjusting lighting according to temperature. The device comprises a temperature detection circuit, a control circuit, a drive circuit and a light-emitting circuit, wherein the control circuit is respectively connected with the temperature detection circuit and the drive circuit, the drive circuit is connected with the light-emitting circuit; the temperature detection circuit is configured to detect the temperature information of a target device, and convert the temperature information into a feedback signal; the control circuit is configured to adjust a driving signal input to the drive circuit according to the feedback signal; the drive circuit is configured to adjust a light-emitting state of the light-emitting circuit according to the driving signal.

In one of the embodiments, the device further comprises a power supply adjustment circuit and a power supply input circuit, the power supply input circuit is connected to an input end of the power supply adjustment circuit, an output end of the power supply adjustment circuit is connected with the light-emitting circuit, and an adjustment end of the power supply adjustment circuit is connected with the control circuit; the power supply input circuit is configured to connect with an external power supply; the control circuit is configured to adjust an adjustment signal input to the adjustment end of the power supply adjustment circuit according to the feedback signal; the power supply adjusting circuit is configured to adjust a voltage input to the light-emitting circuit according to the adjustment signal, so as to change a light-emitting brightness of the light-emitting circuit.

In one of the embodiments, the light-emitting circuit comprises at least two groups of light-emitting units, each group of the light-emitting units comprises a plurality of light-emitting diodes, and anodes of the light-emitting diodes are connected to the output end of the power supply adjustment circuit, and cathodes of the light-emitting diodes are connected to the corresponding drive circuit.

In one of the embodiments, the light-emitting diodes are single-color light-emitting diodes or dual-color light-emitting diodes.

In one of the embodiments, the drive circuit comprises at least two groups of drive units, each group of the drive units comprises an electronic switch, and the electronic switch is connected with the control circuit to selectively turn on the corresponding electronic switch by the driving signal.

In one of the embodiments, the electronic switch is a triode or a transistor.

In one of the embodiments, the temperature detection circuit is a thermistor or a thermal capacitor.

In order to solve the above-mentioned technical problems, a technical solution adopted in the present disclosure is to provide a method for adjusting light according to temperature, the method is applied to the device in the present disclosure, comprises: the temperature detection circuit detects the temperature information of the target device, and converts the temperature information into a feedback signal; the control circuit adjusts the driving signal input to the drive circuit according to the feedback signal; the drive circuit adjusts the light-emitting state of the light-emitting circuit according to the driving signal, wherein the light-emitting state includes a flickering frequency and a light-emitting color.

In one of the embodiments, the method further comprises: the control circuit adjusts an adjustment signal input to the adjustment end of the power supply adjustment circuit according to the feedback signal; the power supply adjusting circuit adjusts a voltage input to the light-emitting circuit according to the adjusting signal, so as to change a light-emitting brightness of the light-emitting circuit.

In one of the embodiments, the control circuit adjusts the driving signal input to the drive circuit according to the feedback signal comprising: the control circuit pre-establishes a mapping table of the feedback signal and the driving signal, queries the mapping table to determine a driving signal matching the feedback signal, and inputs the driving signal to the drive circuit.

The beneficial effects of the present disclosure: the present disclosure provides a device and method for adjusting light according to temperature, the device comprises a temperature detection circuit, a control circuit, a drive circuit and a light-emitting circuit, wherein the control circuit is respectively connected with the temperature detection circuit and the drive circuit, the drive circuit is connected with the light-emitting circuit; the temperature detection circuit is configured to detect the temperature information of a target device, and convert the temperature information into a feedback signal; the control circuit is configured to adjust a driving signal input to the drive circuit according to the feedback signal; the drive circuit is configured to adjust a light-emitting state of the light-emitting circuit according to the driving signal. In the present disclosure, the color, the intensity changes, and a periodic on or off of the light are adjusted according to the temperature which could present a dynamic effect and is full of life interest.

### BRIEF DESCRIPTION OF DRAWINGS

In order to explain the technical solutions of the embodiments of the present disclosure more clearly, the following briefly introduces the drawings that need to be used in the embodiments of the present disclosure. Obviously, the drawings described below are only some embodiments of the present disclosure, and for those of ordinary skill in the art, other drawings can also be obtained from these drawings without creative effort.

FIG. 1 is a structural schematic diagram of a device for adjusting light according to temperature according to an embodiment of the present disclosure.

FIG. 2 is a structural schematic diagram of another device for adjusting light according to temperature according to an embodiment of the present disclosure.

FIG. 3 is a schematic diagram of a partial circuit structure of a device for adjusting light according to temperature according to an embodiment of the present disclosure.

Wherein, the numeral in the drawings:

control circuit 1, drive circuit 2, drive unit 21, electronic switch 211, light-emitting circuit 3, light-emitting unit 31, light-emitting diode 311, temperature detection circuit 4, power supply adjusting circuit 5, power supply input circuit 6.

### DETAILED DESCRIPTION

The technical solutions in the embodiments of the present disclosure will be clearly and completely described below with reference to the drawings in the embodiments of the present disclosure. Obviously, the described embodiments are only a part of the embodiments of the present disclosure, but not all of the embodiments. Based on the embodiments in the present disclosure, all other embodiments obtained by those skilled in the art without creative work fall within the protection scope of the present disclosure.

In the description of this disclosure, it should be understood that the terms “center”, “longitudinal”, “lateral”, “length”, “width”, “thickness”, “upper”, “lower”, “front”, “The orientation or positional relationship indicated by “rear”, “left”, “right”, “vertical”, “horizontal”, “top”, “bottom”, “inside”, “outside”, etc. is based on the orientation or the position relationship shown in the drawings. And they are only for the convenience of describing the present disclosure and simplifying the description, rather than indicating or implying that the indicated device or element must have a specific orientation, be constructed and operated in a specific orientation, and therefore should not be construed as a limitation on the present disclosure. In addition, the terms “first” and “second” are only used for descriptive purposes, and should not be construed as indicating or implying relative importance or implying the number of indicated technical features. Thus, features defined as “first”, “second” may expressly or implicitly include one or more features. In the description of the present disclosure, “plurality” means two or more, unless otherwise expressly and specifically defined.

In this application, the word “exemplary” is used to mean “serving as an example, illustration, or illustration.” Any embodiment described in this application as “exemplary” is not necessarily to be construed as preferred or advantageous over other embodiments. The following description is presented to enable any person skilled in the art to make and use the present disclosure. In the following description, details are set forth for the purpose of explanation. It is to be understood that one of ordinary skill in the art can realize that the present disclosure may be practiced without the use of these specific details. In other embodiment, well-known structures and procedures have not been described in detail so as not to obscure the description of the present disclosure with unnecessary detail. Therefore, this application is not intended to be limited to the embodiments shown but is to be accorded the widest scope consistent with the principles and features disclosed herein.

It should be noted that, since the methods in the embodiments of the present disclosure are executed in electronic devices, the processing objects of each electronic device exist in the form of data or information, such as time, which is essentially time information. It can be understood that in subsequent embodiments, If the size, quantity, location, etc. are mentioned, the corresponding data exists for processing by the electronic device, and details are not repeated here.

### Embodiment 1

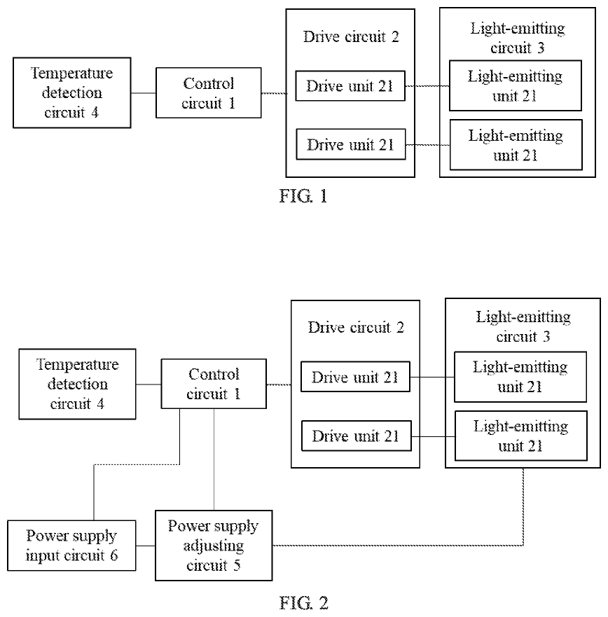

Refer to FIG. 1 and FIG. 2, the present embodiment provides a device for adjusting lighting according to temperature, and the device may specifically be an indicator light on a bread machine, an indicator light on a coffee machine, an indicator light on a kettle, or an indicator light on an oven and other devices that can feed back its operating status through lights.

In the present embodiment, the device comprises a control circuit 1, a drive circuit 2, a light-emitting circuit 3 and a temperature detection circuit 4, the control circuit 1 is respectively connected with the temperature detection circuit 4 and the drive circuit 2, the drive circuit 2 is connected with the light-emitting circuit 3, wherein the temperature detection circuit 4 is a thermistor or a thermal capacitor.

In actual use, the temperature detection circuit 4 is configured to detect the temperature information of the target device, and convert the temperature information into a feedback signal, wherein the feedback signal can be a voltage signal; the control circuit 1 is configured to adjust a driving signal input to the drive circuit 2 according to the feedback signal; the drive circuit 2 is configured to adjust a light-emitting state of the light-emitting circuit 3 according to the drive signal. The light-emitting state includes a flickering frequency and a light-emitting color, and the driving signal can be a pulse signal, and the flickering frequency of the light-emitting circuit 3 can be adjusted by changing the duty ratio of the pulse signal.

Further, the device also includes a power supply adjustment circuit 5 and a power supply input circuit 6, the power supply input circuit 6 is connected to the input end of the power supply adjustment circuit 5, and the output end of the power supply adjustment circuit 5 is connected to the light-emitting circuit 3. The adjustment end of the power supply adjustment circuit 5 is connected to the control circuit 1; the power input circuit 6 is configured to connect with an external power supply signal; the control circuit 1 is configured to adjust an adjustment signal input to the adjustment end of the power supply adjustment circuit 5 according to the feedback signal; the power supply adjustment circuit 5 is configured to adjust a voltage input to the light-emitting circuit 3 according to the adjustment signal, so as to change a light-emitting brightness of the light-emitting circuit 3.

Wherein, the power input circuit 6 comprises a rectifier unit and a voltage regulator unit. The power input circuit 6 is connected to a voltage of 110V, and then converts the voltage of 110V into a voltage of 5V as a power input.

The power supply adjustment circuit 5 comprises an input end, an output end and an adjustment end. The input end is connected to the power supply input circuit 6 to receive 5V voltage; the adjustment end is connected to the control circuit 1 for receiving adjustment signals; the output end is connected to the light-emitting circuit 3, the output end outputs the corresponding voltage according to the adjustment signal received by the adjustment end, so as to change the voltage input to the light-emitting circuit 3 to achieve the purpose of changing the light-emitting brightness.

In an optional embodiment, the light-emitting circuit 3 comprises at least two groups of light-emitting units, and each group of the light-emitting units comprises a plurality of light-emitting diodes 311, and anodes of the light-emitting diodes 311 are connected to the output end of the power supply adjustment circuit 5, and cathodes of the light-emitting diodes 311 are connected to the corresponding drive circuit 2. Wherein, the light-emitting diodes 311 are single-color light-emitting diodes or dual-color light-emitting diodes, and the light-emitting diodes 311 may be red light-emitting diodes, white light-emitting diodes, orange light-emitting diodes, or blue light-emitting diodes and so on, which can be determined according to the actual situation.

In an optional embodiment, the drive circuit 2 comprises at least two groups of drive units 21, each group of the drive units 21 includes an electronic switch 211, and the electronic switch 211 is connected to the control circuit 1 to selectively turn on the corresponding electronic switch 211 by the driving signal, thereby changing the light-emitting color of the light-emitting circuit. Wherein, the electronic switch 211 is a triode or a transistor.

In a practical application scenario, the light-emitting circuit 3 comprises four groups of light-emitting units, and the drive circuit 2 comprises four groups of drive units 21, and the drive units 21 are connected to the light-emitting units in a one-to-one correspondence.

In an optional embodiment, the electronic switch 211 is a triode, the base of the triode is connected to one of the pins of the control circuit 1 for receiving the corresponding driving signal, the emitter of the triode is grounded, and the collector of the triode is connected to the cathode of the light-emitting diode. In addition, the anode of the light-emitting diode is connected to the output end of the power supply adjustment circuit 5.

In actual use, a mapping table of temperature interval, feedback signal, lighting state and driving signal is pre-defined. The control circuit 1 obtains the feedback signal, and then queries the mapping table to determine the driving signal that needs to be output at present, so as to control the corresponding pins to output the corresponding level, and the corresponding transistor is selectively turned on. When a certain transistor is turned on, the cathode of the light-emitting diode is grounded, and the light-emitting diode is lit.

In this embodiment, the external power supply provides the required energy to the device. The core component is the MCU circuit. The MCU is connected to the temperature sensor NTC, and is simultaneously connected to a plurality of drive circuits 2, which are connected to a plurality of LEDs. When the power is turned on, the temperature sensor NTC generates different resistance values according to different temperatures, and transmits them to the control circuit 1. According to the different resistance values, the control circuit 1 outputs different driving voltages and driving signals of different colors to the drive circuit 2. The drive circuit 2 drive LEDs of different colors to achieve changes in light intensity and color with temperature changes.

In this embodiment, the device can adjust the color of the light according to the temperature change, and can also realize the dynamic effect of intensity change and periodic on and off, feedback the running state in real time, and the expression form is interesting. In the impetuous urban life, it brings users a return to nature and a new experience.

### Embodiment 2

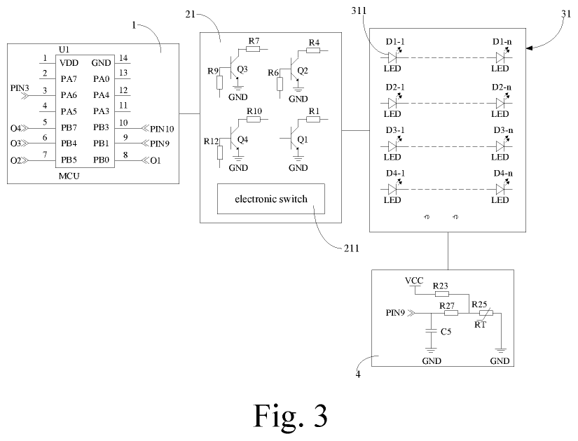

FIG. 3 provides a schematic diagram of a partial circuit structure of a device for adjusting light according to temperature. Refer to FIG. 3, the working principle is briefly described:
(1) 4 groups of orange lamp beads are used to simulate the flame color after lighting. 4 groups of lights with different flickering frequencies to simulate the flickering of flames.
(2) 4 groups of white lamp beads are used, which are mixed with orange lamp beads after lighting. 4 groups of lights with different flickering frequencies.
(3) The white lamp bead light and the orange lamp bead light are mixed to achieve mixed light of different concentrations.
(4) The power supply of the lamp bead is provided by the power adjustment chip. According to the resistance of the thermistor, a voltage control signal is generated, so that the brightness of the lamp bead changes with temperature.
(5) The resistance of the thermistor R22 will vary with temperature. When the temperature increases, the resistance value decreases. The resistance value changes, according to the resistance value, the MCU changes the mixing ratio of orange driving orange and white light, as well as the brightness, so as to realize the color and flickering of the LED emitting simulated flame.

It should be noted that the light-emitting components are light strips, and each light strip is provided with at least 2 light-emitting diodes 311 or other light sources, such as 3, 4, 5 and so on, which is not limited by the number. There is at least one light strip, in this embodiment there are 4 light strips, it can also be 5, 6, 7 and so on, which is not limited by the number. With the increase of the light source, the more the change value, the better the change effect displayed.

### Embodiment 3

Based on the device of the foregoing embodiment 1, this embodiment also provides a method for adjusting light according to temperature. The method is applied to the device as described in embodiment 1 or 2, and specifically comprises the following steps:

The temperature detection circuit detects the temperature information of the target device and converts the temperature information into a feedback signal; the control circuit adjusts the drive signal input to the drive circuit according to the feedback signal; the drive circuit adjusts a flickering frequency and a light-emitting color of the light-emitting circuit according to the driving signal.

Specifically, the control circuit pro-establishes a mapping table of the feedback signal and the driving signal, queries the mapping table to determine a driving signal matching the temperature information, and inputs the driving signal to the driving circuit.

The light-emitting state includes a flickering frequency and a light-emitting color, and the driving signal can be a pulse signal, and the flickering frequency of the light-emitting circuit can be adjusted by changing the duty ratio of the pulse signal.

Wherein, the device further comprises a power supply adjustment circuit and a power supply input circuit, the power supply input circuit is connected with the input end of the power supply adjustment circuit, the output end of the power supply adjustment circuit is connected with the light emitting circuit, and an adjustment end of the power supply adjustment circuit is connected with the control circuit; the power input circuit is configured to connect with an external power supply; the control circuit adjusts the adjustment signal input to the adjustment end of the power supply adjustment circuit according to the feedback signal; the power supply adjustment circuit adjust a voltage input to the light-emitting circuit according to the adjustment signal, so as to change a light-emitting brightness of the light-emitting circuit.

### Embodiment 4

This embodiment provides a kettle, the kettle is provided with the device as described in the present disclosure, and a temperature sensor NTC is installed inside the kettle. At the bottom of the kettle, a piece of PCB is installed. The control circuit, the driving circuit and the light-emitting circuit are installed on the PCB. The light-emitting circuit includes 4 groups of red LEDs and 4 groups of orange LEDs.

When the water temperature is 10-40° C., the LED emits a faint dark red and produces dynamic light and dark changes. When the water temperature is 40-60° C., the LED emits dark red to red, and produces dynamic light and dark changes. When the water temperature is 60-80° C., the LED changes from red to orange-red, and produces dynamic light and dark changes. When the water temperature is 80-90° C., the LED turns from orange-red to light and produces dynamic light and dark changes. When the water temperature is 90-100° C., the LED turns from orange-red to darker, and dynamic light and dark changes are generated. When the water temperature reaches 100° C., the thermostat of the kettle will be disconnected after 6 seconds. The aforementioned temperature interval is the temperature of the water fed back by the temperature sensor NTC after the switch is turned on.

The above descriptions are only four embodiments of the present disclosure, which are not intended to limit the protection scope of the present disclosure. Any equivalent structure or equivalent process transformation made by using the contents of the description and drawings of the present disclosure, or directly or indirectly applied to other relevant technical fields are similarly included within the protection scope of the present disclosure.

What is claimed is:

1. A device for adjusting light according to temperature, comprising: a temperature detection circuit, a control circuit, a drive circuit and a light-emitting circuit, wherein the control circuit is respectively connected with the temperature detection circuit and the drive circuit, the drive circuit is connected with the light-emitting circuit;
the temperature detection circuit is configured to detect the temperature information of a target device, and convert the temperature information into a feedback signal;
the control circuit is configured to adjust a driving signal input to the drive circuit according to the feedback signal;
the drive circuit is configured to adjust a light-emitting state of the light-emitting circuit according to the driving signal.

2. The device according to claim 1, wherein the device further comprises a power supply adjustment circuit and a power supply input circuit, the power supply input circuit is connected to an input end of the power supply adjustment circuit, an output end of the power supply adjustment circuit is connected with the light-emitting circuit, and an adjustment end of the power supply adjustment circuit is connected with the control circuit;
the power supply input circuit is configured to connect with an external power supply;
the control circuit is configured to adjust an adjustment signal input to the adjustment end of the power supply adjustment circuit according to the feedback signal;
the power supply adjusting circuit is configured to adjust a voltage input to the light-emitting circuit according to the adjustment signal, so as to change a light-emitting brightness of the light-emitting circuit.

3. The device according to claim 2, wherein the light-emitting circuit comprises at least two groups of light-emitting units, each group of the light-emitting units comprises a plurality of light-emitting diodes, and anodes of the light-emitting diodes are connected to the output end of the power supply adjustment circuit, and cathodes of the light-emitting diodes are connected to the corresponding drive circuit.

4. The device according to claim 3, wherein the light-emitting diodes are single-color light-emitting diodes or dual-color light-emitting diodes.

5. The device according to claim 3, wherein the drive circuit comprises at least two groups of drive units, each group of the drive units comprises an electronic switch, and the electronic switch is connected with the control circuit to selectively turn on the corresponding electronic switch by the driving signal.

6. The device according to claim 5, wherein the electronic switch is a triode or a transistor.

7. The device according to claim 1, wherein the temperature detection circuit is a thermistor or a thermal capacitor.

8. A method for adjusting light according to temperature, wherein the method is applied to the device according to claim 1, comprising:
the temperature detection circuit detects the temperature information of the target device, and converts the temperature information into a feedback signal;
the control circuit adjusts the driving signal input to the drive circuit according to the feedback signal;
the drive circuit adjusts the light-emitting state of the light-emitting circuit according to the driving signal, wherein the light-emitting state includes a flickering frequency and a light-emitting color.

9. The method according to claim 8, further comprising:
the control circuit adjusts an adjustment signal input to the adjustment end of the power supply adjustment circuit according to the feedback signal;
the power supply adjusting circuit adjusts a voltage input to the light-emitting circuit according to the adjusting signal, so as to change a light-emitting brightness of the light-emitting circuit.

10. The method according to claim 8, wherein the control circuit adjusts the driving signal input to the drive circuit according to the feedback signal comprising:
the control circuit pre-establishes a mapping table of the feedback signal and the driving signal, queries the mapping table to determine a driving signal matching the feedback signal, and inputs the driving signal to the drive circuit.
